(19) United States
(12) Patent Application Publication
(10) Pub. No.: US 2023/0332672 A1
(43) Pub. Date: Oct. 19, 2023

(54) A SHACKLE ASSEMBLY

(71) Applicant: IHC Holland IE B.V., Sliedrecht (NL)

(72) Inventor: David Howell Gunter, Ferndown (GB)

(21) Appl. No.: 17/296,917

(22) PCT Filed: Nov. 20, 2019
(86) PCT No.: PCT/NL2019/050763

§ 371 Date: May 25, 2021

(30) Foreign Application Priority Data
Nov. 28, 2018 (NL) 2022084

(51) Int. Cl. F16G 15/06

(52) U.S. Cl. CPC F16G 15/06

(57) ABSTRACT

A shackle assembly comprises a shackle body, a shackle pin and a pin displacement mechanism for moving the shackle pin along its centerline between a shackle closed position and a shackle open position. The pin displacement mechanism comprises a rotation element which is mounted to the shackle body and rotatable with respect to the shackle body about an axis of rotation which extends perpendicularly to the centerline of the shackle pin and a transmission between the rotation element and the shackle pin for transmitting a rotation of the rotation element to a displacement of the shackle pin along its centerline.

### CROSS-REFERENCE TO RELATED APPLICATION(S)

This Application is a Section 371 National Stage Application of International Application No. PCT/NL2019/050763, filed Nov. 20, 2019 and published as WO 2020/111938 A1 on Jun. 4, 2020, in English.

### BACKGROUND

The present invention relates to a shackle assembly, comprising a shackle body, a shackle pin and a pin displacement mechanism for moving the shackle pin along its centerline between a shackle closed position and a shackle open position.

Such a shackle assembly is known from WO 2013/095107. The known shackle assembly has a driving device which is coupled to the shackle body for driving the shackle pin and is arranged to reciprocate the shackle pin between a shackle closed position and a shackle open position. The driving device comprises a hydraulic cylinder which is mounted at an outer side of the shackle body and extends parallel to the centerline of the shackle pin. A disadvantage of the known shackle assembly is that it takes a lot of space next to the shackle body, in particular in the shackle open position where the hydraulic cylinder is extended. Besides, the centre of gravity of the known shackle assembly is located far from the shackle body.

### SUMMARY

An aspect of the invention is a shackle assembly wherein the pin displacement mechanism comprises a rotation element which is mounted to the shackle body and rotatable with respect to the shackle body about an axis of rotation which extends perpendicularly to the centerline of the shackle pin and a transmission between the rotation element and the shackle pin for transmitting a rotation of the rotation element to a displacement of the shackle pin along its centerline.

The presence of the rotation element and the transmission in the shackle assembly provides the opportunity to create a leveraging effect, hence resulting in a compact unit.

In a particular embodiment the shackle body extends in a main plane, whereas the axis of rotation extends perpendicularly to the main plane. This means that the rotation element can move within the main plane of the shackle body, which provides the opportunity to make the shackle assembly also compact in a direction perpendicularly to the main plane.

The shackle body may comprise a U-shape having a bottom and legs extending from the bottom, whereas end portions of the legs are provided with eyes for receiving the shackle pin, wherein the axis of rotation extends at a level between said bottom and the shackle pin. This allows to minimize the height of the shackle assembly as measured in a direction from the bottom to the eyes.

In a preferred embodiment the rotation element and the transmission form part of a four-bar linkage, wherein the rotation element comprises a first bar which is pivotally coupled to a second bar through a first journal, which second bar is pivotally coupled to a third bar through a second journal remote from the first journal, which third bar is rotatably coupled to the shackle body remote from the second journal, wherein the shackle body forms a fourth bar, wherein the second bar is rotatably coupled to the shackle pin through a pin pivot, wherein the pin pivot lies at a distance from the first and second journals, and wherein the bars and journals are dimensioned and arranged such that the pin pivot is movable in the same direction as the direction of the centerline of the shackle pin.

More specifically the four-bar linkage may form a so-called Hoekens linkage, in which the first journal, the second journal and the pin pivot are aligned. The Hoekens linkage allows the pin pivot to follow a straight path when turning the rotation element by a predefined angle with respect to the shackle body. The shackle assembly will be dimensioned such that the pin pivot follows the straight path between the open and closed shackle position.

The pin pivot may be located outside a circumference of the shackle body in the shackle closed position.

A linear actuator may be rotatably mounted to both the shackle body and the third bar in order to operate the linkage. The linear actuator may be a hydraulic cylinder.

In an alternative embodiment the rotation element comprises a first bar which is pivotally coupled to a second bar through a first journal, which second bar is rotatably coupled to the shackle pin through a pin pivot at a distance from the first journal, and wherein the shackle pin is guided along its centerline by the shackle body. In this case the rotation element forms a crank of a crank mechanism, whereas the second bar forms a connecting rod and the shackle pin forms a piston which is guided by the shackle body. For example, when the shackle body comprises a U-shape having a bottom and legs extending from the bottom, whereas end portions of the legs are provided with eyes for receiving the shackle pin, the shackle pin may be guided by one of the eyes.

A linear actuator may be rotatably mounted to both the first bar and the second bar at a distance from the axis of rotation, the first journal and the pin pivot. The first bar and the second bar form a type of scissors which are rotated with respect to each other through the linear actuator. This means that the stroke of the linear actuator is smaller than the stroke of the shackle pin, which provides the opportunity to create a compact shackle assembly.

An aspect of the invention is also related to a shackle assembly, comprising a shackle body, a shackle pin and a pin displacement mechanism for moving the shackle pin along its centerline between a shackle closed position and a shackle open position, wherein the shackle pin is provided with a lateral projection located at a distance from the shackle body in the shackle closed position, wherein the shackle assembly is provided with a fluid bellow which is located between the lateral projection and the shackle body such that upon introducing a fluid into the fluid bellow it pushes the lateral projection including the shackle pin away from the shackle body, hence moving the shackle pin from the shackle closed position to the shackle open position. This assembly differs from the assembly as described hereinbefore in that it does not have a rotation element and the cooperating transmission. However, due to the presence of the fluid bellow the shackle assembly also has the advantage of a compact shape in a direction along the centerline of the shackle pin. The fluid bellow may be operated by introducing water, for example.

In a practical embodiment the lateral projection is formed by a flange and the fluid bellow surrounds at least a portion of the shackle pin in the shackle open position.

More specifically, the fluid bellow comprise a coil-shaped flexible tube. Introducing a fluid into the tube creates a tubular coil, whereas emptying the tube leads to a folded compact coil.

The shackle pin may engage a spring which is located between the shackle pin and the shackle body so as to move the shackle pin from the shackle open position to the shackle closed position when fluid is released from the fluid bellow.

Alternatively, the lateral projection may be formed by a plate which is reciprocatingly slidable within a cylinder that is fixed to the shackle body, wherein a space in the cylinder at a side of the plate facing away from the shackle body forms a pressure chamber for receiving a pressurized fluid so as to be able to move the shackle pin from the open shackle position to the closed shackle position. The pressure chamber and the fluid bellow may be part of a hydraulic circuit, which is controlled in a conventional manner.

### BRIEF DESCRIPTION OF THE DRAWINGS

Aspects of the invention will hereafter be elucidated with reference to very schematic drawings showing embodiments of the invention by way of example.

FIG. 1 is a perspective view of an embodiment of a shackle assembly.

FIG. 2 is a similar view as FIG. 1, but showing the embodiment from a different side.

FIG. 3 is a side view of the embodiment as shown in FIGS. 1 and 2 including a pictorial representation for illustrating motions of different parts in three different conditions.

FIG. 4 is a diagram which shows a dimensional relationship of bars of a Hoekens linkage.

FIG. 5 is a similar view as FIG. 3, but showing an alternative embodiment.

FIG. 6 is a sectional view of another alternative embodiment of a shackle assembly.

FIG. 7 is a similar view as FIG. 6, but showing the assembly in a different condition.

FIG. 8 is an enlarged view of a part of FIG. 6, indicated by VIII in FIG. 6.

### DETAILED DESCRIPTION

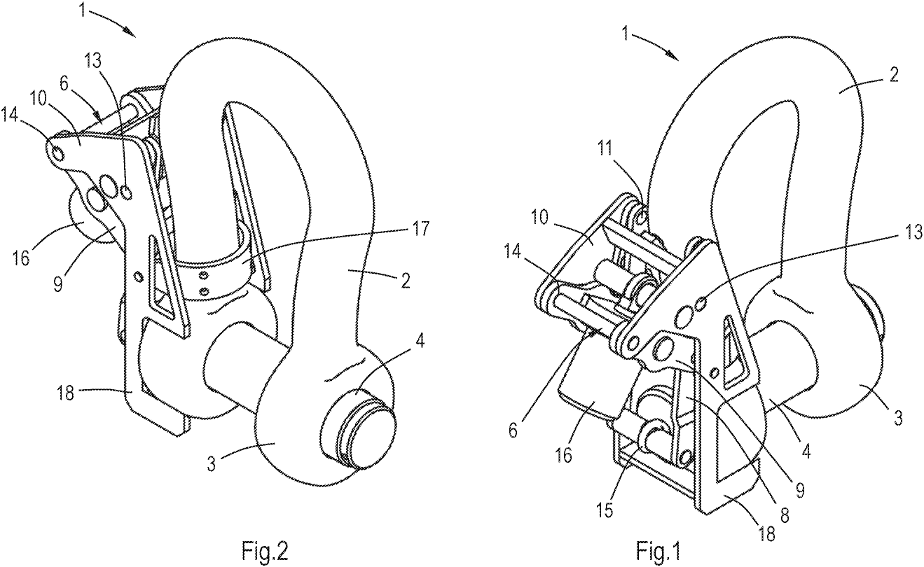

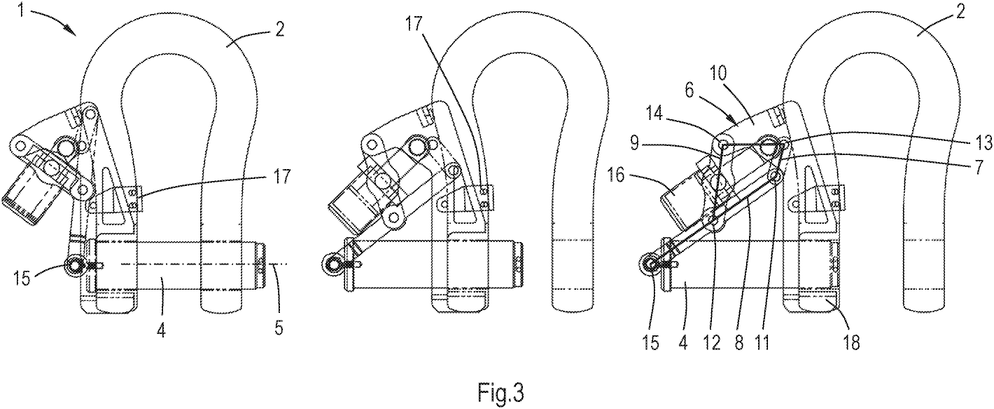

FIGS. 1-3 show an embodiment of a shackle assembly 1. The shackle assembly 1 comprises a U-shaped shackle body 2 which has a bottom and legs which extend from the bottom. The shackle body 2 extends in a main plane. End portions of the legs are provided with eyes 3 in which a shackle pin 4 fits. The shackle pin 4 has a centerline 5 and is movable with respect to the shackle body 2 along its centerline 5 between a shackle closed position and a shackle open position. The leftmost picture of FIG. 3 shows the shackle closed position and the other two pictures show shackle open positions. The rightmost picture shows the shackle pin 4 in an end position.

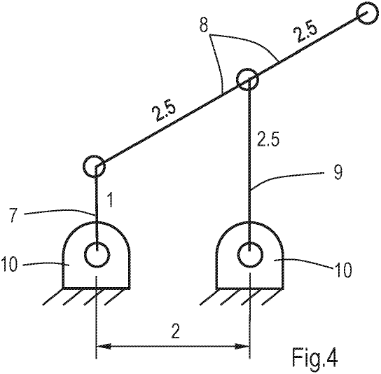

The shackle pin 4 can be moved with respect to the shackle body 2 through a pin displacement mechanism 6, which comprises a four-bar linkage in the form of a so-called Hoekens linkage, which linkage is illustrated by additional lines in the rightmost picture of FIG. 3. Furthermore, FIG. 4 shows a dimensional relationship of a Hoekens linkage in more detail.

The displacement mechanism 6 is provided with a first bar 7, a second bar 8 and a third bar 9. A fourth bar is formed by a support 10 which is fixed to the shackle body 2. The first bar 7 is pivotally coupled to the second bar 8 through a first journal 11 and the second bar 8 is pivotally coupled to the third bar 9 through a second journal 12 which is located at a distance from the first journal 11. The first bar 7 is rotatably coupled to the support 10 through a third journal 13 which is located at a distance from the first journal 11 and the third bar 9 is rotatably coupled to the support 10 through a fourth journal 14 which is located at a distance from the second journal 12 and the third journal 13. The axes of rotation of the journals 11-14 extend perpendicularly to the main plane of the shackle body 2.

The second bar 8 is rotatably coupled to an end of the shackle pin 4 at a pin pivot 15 whereas the second journal 12 lies halfway of the second bar 8 between the first journal 11 and the pin pivot 15. The leftmost picture of FIG. 3 shows that the pin pivot 15 is located outside the shackle body 2 in the shackle closed position. A plane through axes of rotation of the third and fourth journals 13, 14 extends parallel to a plane in which the centerline 5 and an axis of rotation of the pin pivot 15 lies. The pin pivot 15 and the first to fourth journals 11-14 are arranged such that the axis of rotation of the pin pivot 15 is movable along the centerline 5 of the shackle pin 4, as demonstrated in FIG. 3. The dimensionless distances between the first to fourth journals 11-14 and the pin pivot 15 are illustrated in FIG. 4. The arrangement of the Hoekens linkage as shown in FIGS. 1-4 allows the pin pivot 15 to follow a straight path when turning the first bar 7 by a predefined angle with respect to the shackle body 2.

The displacement mechanism 6 is also provided with a hydraulic actuator 16 of which one side is rotatably coupled to the support 10 and another side is rotatably coupled to the third bar 9. The rightmost picture of FIG. 3 shows that even in the end position of the shackle pin 4 the displacement mechanism 6 does not extend beyond the pin pivot 15 as seen from the shackle body 2, which creates a compact shackle assembly 1. FIG. 3 shows that the stroke of the hydraulic actuator 16 is smaller than the stroke of the pin pivot 15, which is caused by applying the Hoekens linkage. It is noted that the hydraulic actuator may be replaced by any alternative actuator or an actuator may be omitted such that the displacement mechanism 6 can be operated manually, remotely and/or by means of an ROV when in underwater operations. The skilled person will appreciate that such operating mechanism is not illustrated, but that it can imply any kind of actuating and control system implemented into the displacement mechanism 6.

The support 10 is fixed to the shackle body 2 by a bracket 17 which is clamped about one of the legs of the shackle body 2. The support 10 also comprises two parallel feet 18 which extend parallel to the centerline 5 of the shackle pin 4 at an outer side of one eye 3 of the shackle body 2. This allows the shackle assembly 1 to rest in upright orientation on the ground as shown in FIGS. 1-3.

In the embodiment as shown in FIGS. 1-3 the first bar 7 may be seen as being a rotation element which is mounted to the shackle body 2 and which is rotatable with respect to the shackle body 2 about an axis of rotation which extends at a distance from and perpendicularly to the centerline 5 of the shackle pin 4. The rotation element and the shackle pin 4 are connected to each other via a transmission in the form of the second bar 8, the third bar 9 and the cooperating journals 11, 12 and 14 which results in a straight movement of the pin pivot 15 between the open and closed shackle position of the shackle pin 4. This means that transverse forces between the shackle pin 4 and the shackle body 2 are negligible during a movement of the shackle pin 4 between the shackle open position and the shackle closed position. There are also alternative embodiments conceivable in which the transmission between the above-mentioned rotation element and the pin pivot 15 is different.

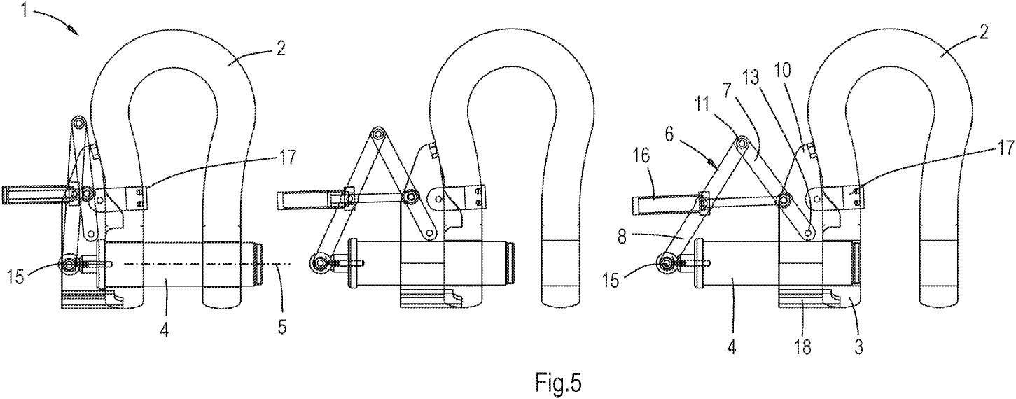

FIG. 5 shows an alternative embodiment of the shackle assembly 1. Parts of the embodiment as shown in FIG. 5 which are similar to parts in the embodiment as shown in FIGS. 1-3 have the same reference signs. The pin displacement mechanism 6 of the embodiment as shown in FIG. 5 is a type of crank mechanism, in which the first bar 7 forms a crank, the second bar 8 forms a connecting rod and the shackle pin 4 forms a piston which is guided by one eye 3 of the shackle body 2. The first bar 7 is rotatably coupled to the support 10 through the third journal 13 and pivotally coupled to the second bar 8 through the first journal 11 at a distance from the third journal 13. The second bar 8 is rotatably coupled to an end of the shackle pin 4 at the pin pivot 15 remote from the first journal 11. Due to the guidance by the eye 3 the shackle pin 4 is movable along the centerline 5, as demonstrated in FIG. 5.

The hydraulic actuator 16 is rotatably coupled to the first bar 7 and the second bar 8. FIG. 5 shows that the stroke of the hydraulic actuator 16 is smaller than the stroke of the pin pivot 15, which is caused by applying the crank mechanism and the location of mounting the hydraulic actuator 16.

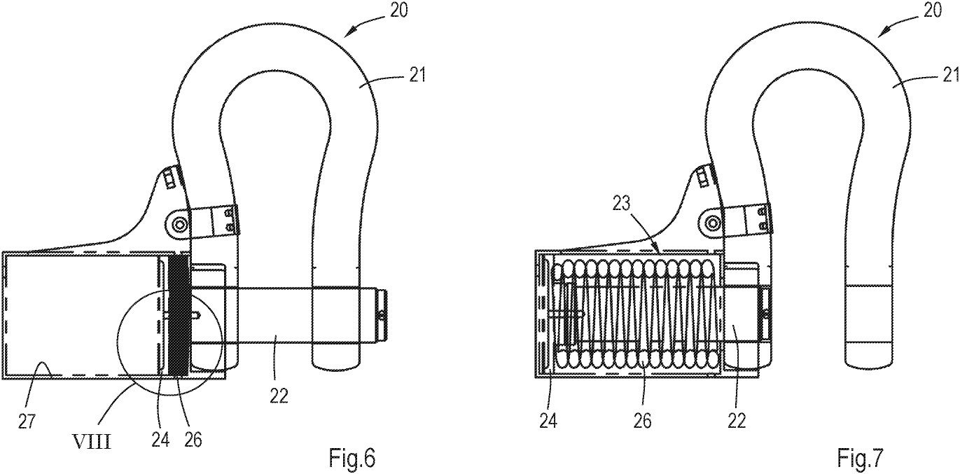

FIGS. 6-8 show another alternative embodiment of a shackle assembly 20. This embodiment also comprises a shackle body 21, a shackle pin 22 and a pin displacement mechanism 23 for moving the shackle pin 22 along its centerline between a shackle closed position and a shackle open position. However, the pin displacement mechanism 23 does not comprise a rotation element like the embodiments as described hereinbefore.

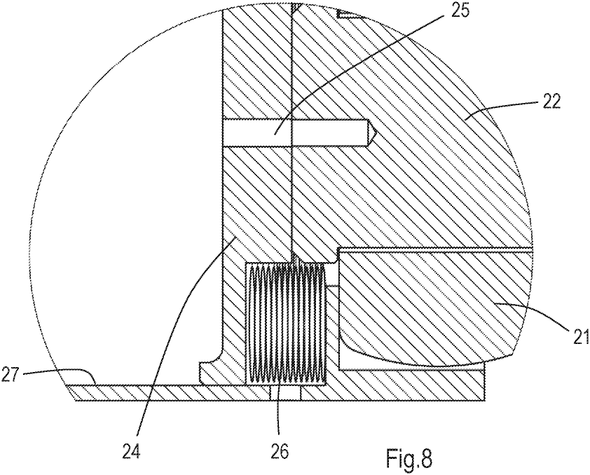

FIG. 8 shows that a circular plate 24 is fixed to the shackle pin 22 through a connector pin 25. The circular plate 24 is located at a distance from the shackle body 21 in the shackle closed position, which is shown in FIGS. 6 and 8. The shackle assembly 20 is provided with a fluid bellow in the form of a coil-shaped flexible tube 26 which is located between the shackle body 21 and the plate 24. The plate 24 is movable within a cylinder 27 which holds the tube 26 in coil shape when a fluid is introduced into the tube 26 such that it expands as shown in FIG. 7. Due to expanding the tube 26 the plate 24 including the shackle pin 22 is moved in a direction away from the shackle body 21, hence moving the shackle pin 22 from the shackle closed position to the shackle open position. In the shackle open position the expanded coiled tube 26 surrounds the retracted shackle pin 22, see FIG. 7. It is noted that mounting the circular plate 24 to the shackle pin 22 by the connector pin 25 can be applied to a shackle pin of a standard conventional shackle assembly.

In order to move the shackle pin 22 from the shackle open position to the shackle closed position a fluid is introduced into the cylinder 27 at a side of the plate 24 opposite to the side where the tube 26 is located. Upon exerting a force onto the plate 24 in a direction in which the shackle pin 22 moves from the shackle open position to the shackle closed position the fluid in the tube 26 can be discharged so as to allow the tube 26 to shrink. This condition is shown in FIGS. 6 and 8.

In an alternative embodiment the shackle assembly 20 may be provided with a spring which is located at a side of the plate 24 opposite to the side where the tube 26 is located. During introducing a fluid into the tube 26 and moving the plate 24 in a direction away from the shackle body 21 the spring is loaded whereas the spring will move the shackle pin 22 back upon discharging the fluid from the tube 26.

Filling and emptying the tube 26 and the cylinder 27 may be controlled by a hydraulic controller, for example.

The invention is not limited to the embodiments shown in the drawings and described hereinbefore, which may be varied in different manners within the scope of the claims and their technical equivalents.

1. A shackle assembly, comprising a shackle body, a shackle pin and a pin displacement mechanism for moving the shackle pin along its centerline between a shackle closed position and a shackle open position, wherein the pin displacement mechanism comprises a rotation element which is mounted to the shackle body and rotatable with respect to the shackle body about an axis of rotation which extends perpendicularly to the centerline of the shackle pin and a transmission between the rotation element and the shackle pin configured to transmit a rotation of the rotation element to a displacement of the shackle pin along its centerline.

2. The shackle assembly according to claim 1, wherein the shackle body extends in a main plane and wherein the axis of rotation extends perpendicularly to said main plane.

3. The shackle assembly according to claim 2, wherein the shackle body comprises a U-shape having a bottom and legs extending from the bottom, wherein end portions of the legs are provided with eyes for receiving the shackle pin, wherein the axis of rotation extends at a level between said bottom and the shackle pin.

4. Theshackle assembly according to claim 3, wherein the rotation element and the transmission form part of a four-bar linkage, wherein the rotation element comprises a first bar which is pivotally coupled to a second bar through a first journal, which second bar is pivotally coupled to a third bar through a second journal remote from the first journal, which third bar is rotatably coupled to the shackle body remote from the second journal, wherein the shackle body forms a fourth bar, wherein the second bar is rotatably coupled to the shackle pin through a pin pivot, wherein the pin pivot lies at a distance from the first and second journals, and wherein the bars and the journals are dimensioned and arranged such that the pin pivot is movable in the same direction as a direction of the centerline of the shackle pin.

5. The shackle assembly according to claim 4, wherein the four-bar linkage forms a Hoekens linkage, in which the first journal, the second journal and the pin pivot are aligned.

6. The shackle assembly according to claim 5, wherein the pin pivot is located outside a circumference of the shackle body in the shackle closed position.

7. The shackle assembly according to claim 6, wherein a linear actuator is rotatably mounted to both the shackle body and the third bar.

8. The shackle assembly according to claim 1, wherein the rotation element comprises a first bar which is pivotally coupled to a second bar through a first journal, which second bar is rotatably coupled to the shackle pin through a pin pivot at a distance from the first journal, and wherein the shackle pin is guided along its centerline by the shackle body.

9. The shackle assembly according to claim 8, wherein a linear actuator is rotatably mounted to both the first bar and the second bar at a distance from the axis of rotation, the first journal and the pin pivot.

10. A shackle, comprising a shackle body, a shackle pin and a pin displacement mechanism configured to move the shackle pin along its centerline between a shackle closed position and a shackle open position, wherein the shackle pin is provided with a lateral projection located at a distance from the shackle body in the shackle closed position, wherein the shackle assembly is provided with a fluid bellow which is located between the lateral projection and the shackle body such that upon introducing a fluid into the fluid bellow the fluid pushes the lateral projection including the shackle pin away from the shackle body, hence moving the shackle pin from the shackle closed position to the shackle open position.

11. The shackle assembly according to claim 10, wherein the lateral projection is formed by a flange and the fluid bellow surrounds at least a portion of the shackle pin in the shackle open position.

12. The shackle assembly according to claim 11, wherein the fluid bellow comprises a coil-shaped flexible tube.

13. The shackle assembly according to claim 12,wherein the shackle pin engages a spring which is located between the shackle pin and the shackle body so as to move the shackle pin from the shackle open position to the shackle closed position when fluid is released from the fluid bellow.

14. The shackle assembly according to claim 12, wherein the lateral projection is formed by a plate which is reciprocatingly slidable within a cylinder that is fixed to the shackle body, wherein a space in the cylinder at a side of the plate facing away from the shackle body forms a pressure chamber for receiving a pressurized fluid so as to be able to move the shackle pin from the open shackle position to the closed shackle position.

15. The shackle assembly according to claim 10, wherein the shackle pin engages a spring which is located between the shackle pin and the shackle body so as to move the shackle pin from the shackle open position to the shackle closed position when fluid is released from the fluid bellow.

16. The shackle assembly according to claim 10, wherein the lateral projection is formed by a plate which is reciprocatingly slidable within a cylinder that is fixed to the shackle body, wherein a space in the cylinder at a side of the plate facing away from the shackle body forms a pressure chamber for receiving a pressurized fluid so as to be able to move the shackle pin from the open shackle position to the closed shackle position.

17. The shackle asscmbly according to claim 3, wherein the rotation element and the transmission form part of a four-bar linkage, wherein the rotation element comprises a first bar which is pivotally coupled to a second bar through a first journal, which second bar is pivotally coupled to a third bar through a second journal remote from the first journal, which third bar is rotatably coupled to the shackle body remote from the second journal, wherein the shackle body forms a fourth bar, wherein the second bar is rotatably coupled to the shackle pin through a pin pivot, wherein the pin pivot lies at a distance from the first and second journals, and wherein the bars and the journals are dimensioned and arranged such that the pin pivot is movable in the same direction as a direction of the centerline of the shackle pin.

18. The shackle assembly according to claim 4, wherein the pin pivot is located outside a circumference of the shackle body in the shackle closed position.

19. The shackle assembly according to claim 4, wherein a linear actuator is rotatably mounted to both the shackle body and the third bar.
